(19) United States
(12) Patent Application Publication
(10) Pub. No.: US 2019/0391446 A1
(43) Pub. Date: Dec. 26, 2019

(54) APPARATUS FOR ATTACHING POLARIZED PLATE WITH CHECK MARK AND CHECKING METHOD THEREFOR

(71) Applicants: HKC CORPORATION LIMITED, SHENZHEN CITY, GUANGDONG (CN); CHONGQING HKC OPTOELECTRONICS TECHNOLOGY CORPORATION LIMITED, CHONGQING (CN)

(72) Inventor: CHUN-CHIN HUANG, CHONGQING (CN)

(21) Appl. No.: 15/540,933

(22) PCT Filed: Mar. 3, 2017
(86) PCT No.: PCT/CN2017/075545

§ 371 Date: Jun. 29, 2017

(30) Foreign Application Priority Data
Dec. 22, 2016 (CN) 201611200771.0

(51) Int. Cl. G02F 1/1335; B32B 38/16

(52) U.S. Cl. CPC G02F 1/133528; B32B 38/162; G02F 1/133602

(57) ABSTRACT

This application relates to an apparatus for attaching a polarized plate with check mark and a checking method therefor. The apparatus includes: a carrying platform, configured to carry a polarized plate, where the polarized plate has the check mark; a drawing unit, disposed at one side of the carrying platform and configured to draw the polarized plate out of the carrying platform; an image sensing and processing unit, disposed above the drawing unit and configured to photograph the mark of the polarized plate and to compare the mark with a mark of a polarized plate standard template to determine whether the marks conform to each other; a cleaning unit, disposed at one side of the drawing unit and configured to clean the polarized plate from the drawing unit; and an alignment unit, disposed at one side of the cleaning unit and configured to align the polarized plate from the cleaning unit with a display panel.

### BACKGROUND

### Technical Field

This application relates to a method for improving mismatching of a polarized plate, and in particular, to an apparatus for attaching a polarized plate with at least one check mark and a checking method therefor.

### Related Art

Generally, a liquid crystal display may be classified into a simple matrix type and an active matrix type according to drive display manners. In a display of the simple matrix type, mainly, staggered transparent electrodes and filling liquid crystal are separately disposed on an upper panel and a lower panel. Grid-shaped units with crossed electrodes are pixels of a liquid crystal panel, and electrodes in two directions control a potential difference between two poles of the pixels by using an externally provided drive voltage, to drive rotation of liquid crystal in the pixels. In a display of the active matrix type, a switching element and an auxiliary capacitor for storing a signal are disposed at a location of each pixel on a panel, and drive of each pixel is independently controlled by a thin film transistor component on the pixel.

For each of the display of the simple matrix type and the display of the active matrix type, a polarized plate needs to be attached to the outside of a panel thereof, and a main purpose of the polarized plate is to enable a light source to generate a phase difference when there is an electric field and there is no electric field and present a bright or dark state, to display a subtitle or an image. When a pollutant, such as a foreign matter and an impurity, remains between the panel and the polarized plate, display quality is affected. Therefore, it is quite important to keep cleanness and alignment of a panel and a polarized plate in a process of manufacturing a liquid crystal panel of a display.

In a liquid crystal display, a polarized plate is one of indispensable components. The polarized plate is configured to polarize light rays that originally have no polarity into polarized light. Therefore, the liquid crystal display can control passing of light rays and presentation of color signals by using the polarized light and twisted features of liquid crystal molecules. Moreover, in recent years, as liquid crystal display components are widely applied to various electronic devices such as word processors, computer screens, mobile phones, or liquid crystal televisions, there is a growing demand for polarized plates. Therefore, how to improve efficiency of a manufacturing process and improve product yields is a management problem that operators need to deal with.

### SUMMARY

To resolve the foregoing technical problem, an objective of the present application is to provide a method for improving mismatching of a polarized plate, and in particular, an apparatus for attaching a polarized plate with at least one check mark and a checking method therefor, so as to effectively resolve a mismatching problem of a polarized plate of a conventional polarizer attaching machine.

The objective of this application is achieved and the technical problem of this application is resolved by using the following technical solutions. According to this application, an apparatus for attaching a polarized plate with at least one check mark is provided, comprising: a carrying platform, configured to carry a polarized plate, where the polarized plate has the check mark; a drawing unit, disposed at one side of the carrying platform and configured to draw the polarized plate out of the carrying platform; an image sensing and processing unit, disposed above the drawing unit and configured to photograph the check mark of the polarized plate and to compare the mark with a mark of a polarized plate standard template to determine whether the marks conform to each other; a cleaning unit, disposed at one side of the drawing unit and configured to clean the polarized plate from the drawing unit; and an alignment unit, disposed at one side of the cleaning unit and configured to align the polarized plate from the cleaning unit with a display panel.

The objective of this application may also be further achieved and the technical problem of the present application may also be further resolved by using the following technical measure.

A method for checking a polarized plate mark comprises: providing the foregoing apparatus for attaching a polarized plate with at least one check mark; placing a polarized plate on the carrying platform, where the polarized plate has the check mark; drawing the polarized plate out of the carrying platform; photographing the check mark of the polarized plate and comparing the check mark with a mark of a polarized plate standard template to determine whether the marks conform to each other; drawing the polarized plate out when the check mark of the polarized plate does not conform to the mark of the polarized plate standard template; and cleaning the polarized plate when the check mark of the polarized plate conforms to the mark of the polarized plate standard template.

In an embodiment of this application, the image sensing and processing unit comprises a plurality of photographing cameras and a backlight source.

In an embodiment of this application, the image sensing and processing unit further comprises a set of mark comparison software.

In an embodiment of this application, the check mark is an outline mark and/or a color mark.

In an embodiment of this application, the apparatus for attaching a polarized plate with at least one check mark further comprises: a film tearing unit, disposed at one side of the alignment unit and configured to perform film tearing on the polarized plate from the alignment unit; and an attaching unit, disposed at one side of the film tearing unit and configured to attach the polarized plate from the film tearing unit to the display panel.

In an embodiment of this application, the polarized plate comprises a polarizer, a phase difference film, and a protective film.

In an embodiment of this application, the method for checking a polarized plate mark further comprises: comparing the check mark of the polarized plate with the mark of the polarized plate standard template by using mark comparison software; drawing the polarized plate out when the mark comparison software determines that an outline mark of the polarized plate does not conform to an outline mark of the polarized plate standard template; and drawing the polarized plate out when the mark comparison software determines that a color mark of the polarized plate does not conform to a color mark of the polarized plate standard template.

In an embodiment of this application, the method for checking a polarized plate mark further comprises: cleaning the polarized plate when the mark comparison software determines that the outline mark and the color mark of the polarized plate conform to the outline mark and the color mark of the polarized plate standard template.

In an embodiment of this application, the method for checking a polarized plate mark further comprises: photographing the check mark of the polarized plate by using an image sensing and processing unit, and comparing the mark with the mark of the polarized plate standard template to determine whether the marks conform to each other, where the image sensing and processing unit comprises a plurality of photographing cameras and a backlight source.

Beneficial effects of this application are: a mismatching problem of a polarized plate of a conventional polarizer attaching machine can be effectively resolved.

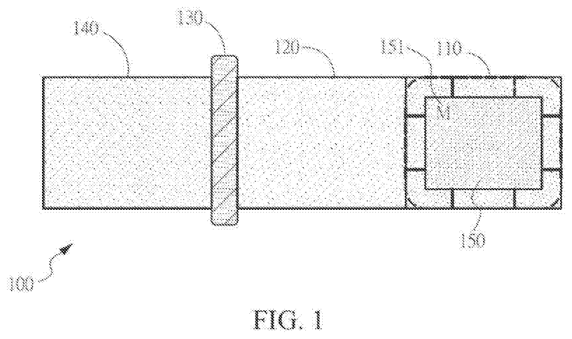

FIG. 1 is a schematic diagram of an exemplary apparatus for attaching a polarized plate;

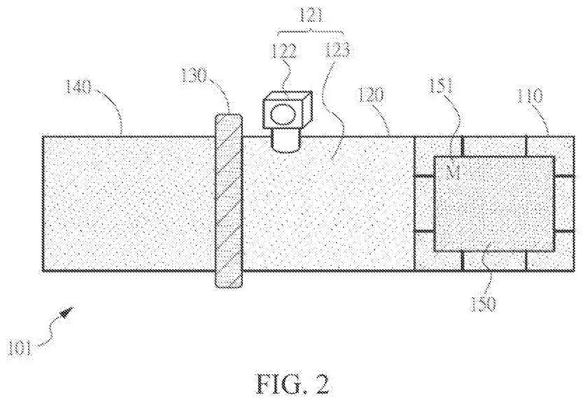

FIG. 2 is a schematic diagram of an apparatus for attaching a polarized plate with at least one check mark according to an embodiment of this application;

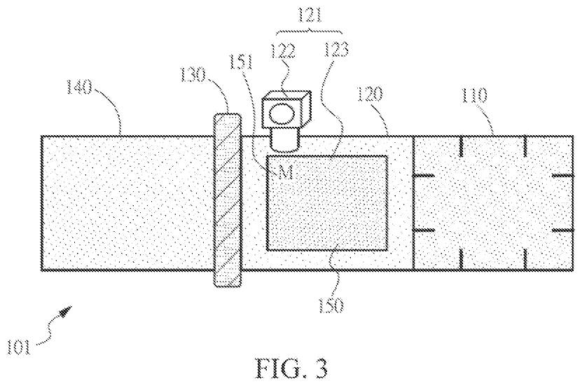

FIG. 3 is a schematic diagram of an apparatus for attaching a polarized plate with at least one check mark according to another embodiment of this application;

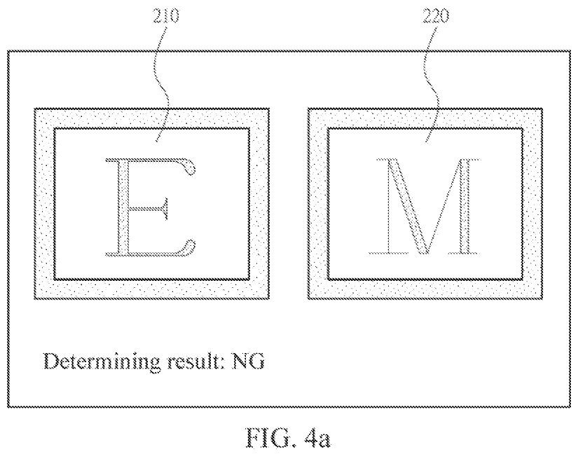

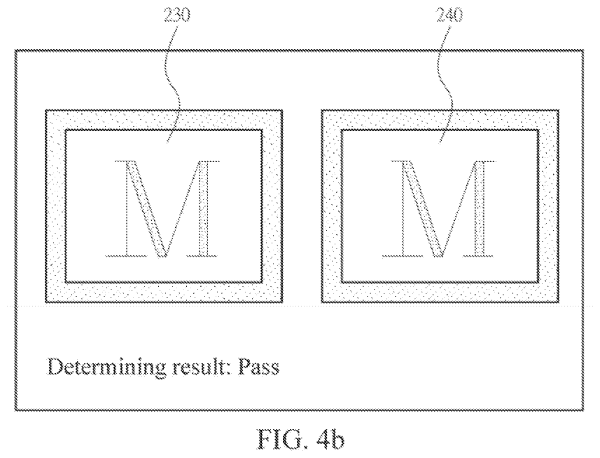

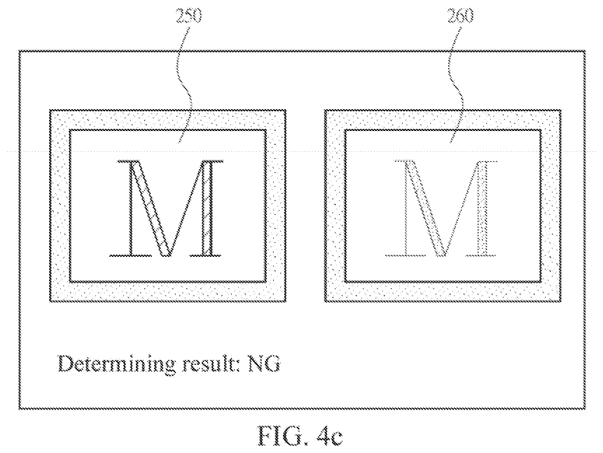

FIG. 4a is a schematic diagram of determining in a method for checking a polarized plate mark according to an embodiment of this application;

FIG. 4b is a schematic diagram of determining in a method for checking a polarized plate check mark according to another embodiment of this application; and

FIG. 4c is a schematic diagram of determining in a method for checking a polarized plate mark according to still another embodiment of this application.

### DETAILED DESCRIPTION

The following embodiments are described with reference to the accompanying drawings, which are used to exemplify specific embodiments for implementation of this application. Terms about directions mentioned in this application, such as “on”, “below”, “front”, “back”, “left”, “right”, “in”, “out”, and “side surface” merely refer to directions of the accompanying drawings. Therefore, the used terms about directions are used to describe and understand this application, and are not intended to limit this application.

The accompanying drawings and the description are considered to be essentially exemplary, rather than limitative. In figures, units with similar structures are represented by using a same reference number. In addition, for understanding and ease of description, a size and a thickness of each component shown in the accompanying drawings are arbitrarily shown, but this application is not limited thereto.

In the accompanying drawings, for clarity, thicknesses of a layer, a film, a panel, an area, and the like are enlarged. In the accompanying drawings, for understanding and ease of description, thicknesses of some layers and areas are enlarged. It should be understood that when a component such as a layer, a film, an area, or a substrate is described to be “on” “another component”, the component may be directly on the another component, or there may be an intermediate component.

In addition, in this specification, unless otherwise explicitly described to have an opposite meaning, the word “include” is understood as including the component, but not excluding any other component. In addition, in this specification, “on” means that a component is located on or below a target component, but does not mean that the component needs to be located on top of a gravity direction.

To further describe the technical means adopted in this application to achieve a predetermined invention objective and effects of this application, specific implementations, structures, features, and effects of an apparatus for attaching a polarized plate with at least one check mark and a checking method therefor provided according to this application are described in detail below with reference to the drawings and preferred embodiments.

A polarized plate includes a laminated optical thin film having a function of a phase difference film on at least one surface. For a polarizer forming the polarized plate, such as a thin film including a polymer obtained by formulating polyvinyl alcohol (PVA) or a of PVA, or a thin film obtained by implementing, in an appropriate sequence or method, dyeing processing, stretching processing, cross-linking processing, and the like by using iodine or a dichroic substance including a dichroic dye, when natural light is incident, the natural light becomes straight polarized light and penetrates through the polarizer. Preferably, transmittance of used light is high, and polarization brightness is great.

A thickness of the polarizer forming the polarized plate is generally 5 μm to 80 μm. The polarizer may use other thin films having same characteristics in addition to the foregoing PVA thin films. For example, if dyeing processing, stretching processing, cross-linking processing, and the like are implemented in an appropriate sequence or method on a thin film including cyclic olefin resin or the thin film is coated with a solution of a dichroic substance, to align the thin film, the thin film may become a polarizer of a wire grid type.

Generally, a polarized plate includes a polarizer, a phase difference film, and a protective film, but in a form of the phase difference film forming the polarized plate, a laminated optical thin film is attached to at least one surface of the polarizer by using a binder or an adhesive for use. The laminated optical thin film may be attached to the polarizer at a side of a layer A, or attached to the polarizer at a side of a layer B. Such a polarized plate has characteristics such as excellent thermostability, excellent wet resistance, and excellent resistance to chemical reagents because of the phase difference film, and has a sufficient function as a protective film. Therefore, on a surface of the polarizer on which a laminated optical thin film that has a function as the phase difference film is laminated, the protective film does not need to be additionally laminated. When the polarized plate includes a laminated optical thin film that is laminated only on a single surface of the polarizer and that has a function as the phase difference film, another surface of the polarizer may be laminated with a well-known protective film such as triacetyl cellulose (TAC), a cyclic olefin resin film, or an acrylic acid resin film.

Attachment of the laminated optical thin film and the polarizer and attachment of the protective film and the polarizer are that layers are attached by using a well-known binder or adhesive such as a pressure sensing binder, a heat curing binder, or an optical curving binder for manufacturing. The adhesive is preferably a binder with good transparency, specifically, for example, an adhesive such as natural rubber, synthetic rubber, an ethenyl ethanoate/chloroethylene copolymer, polyvinylether, PVA, acrylic acid resin, modified polyolefin resin, a hardening adhesive obtained by adding a hardener such as a compound containing an isocyanate plurality to the foregoing resin including a functional plurality such as a hydroxyl or amidogen plurality, a polyurethane dry-layer shared adhesive, a synthetic rubber binder, or an epoxy binder. The polarized plate is preferably a layer including at least one of an auto-reflection preventing layer and an anti-dazzle layer and is preferably disposed outside a surface of the protective film at a side opposite to the polarizer.

FIG. 1 is a schematic diagram of an exemplary apparatus 100 for attaching a polarized plate 150. Referring to FIG. 1, the apparatus 100 for attaching a polarized plate 150 includes: a carrying platform 110, configured to carry a polarized plate 150, where the polarized plate 150 has a check mark 151; a drawing unit 120, disposed at one side of the carrying platform 110 and configured to draw the polarized plate 150 out of the carrying platform 110; a cleaning unit 130, disposed at one side of the drawing unit 120 and configured to clean the polarized plate 150 from the drawing unit 120; an alignment unit 140, disposed at one side of the cleaning unit 130 and configured to align the polarized plate 150 from the cleaning unit 130 with a display panel (not shown in the figure); a film tearing unit (not shown in the figure), disposed at one side of the alignment unit 140 and configured to perform film tearing on the polarized plate 150 from the alignment unit 140; and an attaching unit (not shown in the figure), disposed at one side of the film tearing unit and configured to attach the polarized plate 150 from the film tearing unit to the display panel.

FIG. 2 is a schematic diagram of an apparatus 101 for attaching a polarized plate 150 with the check mark according to an embodiment of this application. FIG. 3 is a schematic diagram of an apparatus 101 for attaching a polarized plate 150 with the check mark according to another embodiment of this application. Referring to FIG. 2 and FIG. 3, in an embodiment of this application, the apparatus 101 for attaching a polarized plate 150 with the check mark includes: a carrying platform 110, a drawing unit 120, an image sensing and processing unit 121, a cleaning unit 130, an alignment unit 140, a film tearing unit (not shown in the figure), and an attaching unit (not shown in the figure). The carrying platform 110 is configured to carry a polarized plate 150, where the polarized plate 150 has the check mark 151. The drawing unit 120 is disposed at one side of the carrying platform 110 and is configured to draw the polarized plate 150 out of the carrying platform 110. The image sensing and processing unit 121 is disposed above the drawing unit 120 and is configured to photograph the check mark 151 of the polarized plate 150 and compare the check mark 151 with a mark of a polarized plate standard template to determine whether the marks conform to each other. The cleaning unit 130 is disposed at one side of the drawing unit 120 and is configured to clean the polarized plate 150 from the drawing unit 120. The alignment unit 140 is disposed at one side of the cleaning unit 130 and is configured to align the polarized plate 150 from the cleaning unit 130 with a display panel (not shown in the figure). The film tearing unit is disposed at one side of the alignment unit 140 and is configured to perform film tearing on the polarized plate 150 from the alignment unit 140. The attaching unit is disposed at one side of the film tearing unit and is configured to attach the polarized plate 150 from the film tearing unit to the display panel.

In an embodiment, the image sensing and processing unit 121 includes a plurality of photographing cameras 122 and a backlight source 123.

In an embodiment, the image sensing and processing unit 121 further includes a set of mark comparison software.

In an embodiment, the check mark 151 is an outline mark and/or a color mark.

In an embodiment, the polarized plate 150 includes a polarizer, a phase difference film, and a protective film.

FIG. 4a is a schematic diagram of determining in a method for checking a polarized plate mark according to an embodiment of this application. FIG. 4b is a schematic diagram of determining in a method for checking a polarized plate mark according to another embodiment of this application. FIG. 4c is a schematic diagram of determining in a method for checking a polarized plate mark according to still another embodiment of this application. Referring to FIG. 3, FIG. 4a, FIG. 4b, and FIG. 4c, in an embodiment of this application, the method for checking a polarized plate mark includes: providing the foregoing apparatus 101 for attaching a polarized plate 150 with check mark; placing a polarized plate 150 on the carrying platform 110, where the polarized plate 150 has the check mark (for example, 210, 230, or 250 shown in FIG. 4a, FIG. 4b, or FIG. 4c); drawing the polarized plate 150 out of the carrying platform 110; photographing the mark 210, 230, or 250 of the polarized plate 150 and comparing the mark 210, 230, or 250 with a mark (for example, 220, 240, or 260 shown in FIG. 4a, FIG. 4b, or FIG. 4c) of a polarized plate standard template to determine whether the marks conform to each other; drawing the polarized plate 150 out when the mark 210 or 250 of the polarized plate 150 does not conform to the mark 220 or 260 of the polarized plate 150 standard template; and cleaning the polarized plate 150 when the mark 230 of the polarized plate 150 conforms to the mark 240 of the polarized plate 150 standard template.

In an embodiment, the method for checking a polarized plate mark further includes: comparing the mark 210, 230, or 250 of the polarized plate 150 and the mark 220, 240, or 260 of the polarized plate 150 standard template by using mark comparison software; drawing the polarized plate 150 out when the mark comparison software determines that an outline mark 210 of the polarized plate 150 does not conform to an outline mark 220 of the polarized plate 150 standard template; and drawing the polarized plate 150 out when the mark comparison software determines that a color mark 250 of the polarized plate 150 does not conform to a color mark 260 of the polarized plate 150 standard template.

In an embodiment, the method for checking a polarized plate mark further includes: cleaning the polarized plate 150 when the mark comparison software determines that the outline mark and the color mark 230 of the polarized plate 150 conform to the outline mark and the color mark 240 of the polarized plate 150 standard template.

In an embodiment, the method for checking a polarized plate mark further includes: photographing, by an image sensing and processing unit 121, the check mark 151 of the polarized plate 150 and comparing the check mark 151 with the mark of the polarized plate 150 standard template to determine whether the marks conform to each other, where the image sensing and processing unit 121 includes a plurality of photographing cameras 122 and a backlight source 123.

In an embodiment, in the method for checking a polarized plate mark, for a device in which comparison of an outline and a color of the polarized plate 150 with the template fails, a result is determined by personnel, and the device is removed if the device is abnormal.

In an embodiment, the apparatus 101 for attaching a polarized plate 150 with check mark includes: a carrying platform 110, a drawing unit 120, an image sensing and processing unit 121, a cleaning unit 130, an alignment unit 140, a film tearing unit (not shown in the figure), and an attaching unit (not shown in the figure). The carrying platform 110 is configured to carry a polarized plate 150, where the polarized plate 150 has the check mark 151. The drawing unit 120 is disposed at one side of the carrying platform 110 and is configured to draw the polarized plate 150 out of the carrying platform 110. The image sensing and processing unit 121 is disposed above the drawing unit unit 120 and is configured to photograph the check mark 151 of the polarized plate 150 and compare the check mark 151 with a mark of a polarized plate standard template to determine whether the marks conform to each other. The cleaning unit 130 is disposed at one side of the drawing unit 120 and is configured to clean the polarized plate 150 from the drawing unit 120. The alignment unit 140 is disposed at one side of the cleaning unit 130 and is configured to align the polarized plate 150 from the cleaning unit 130 with a display panel (not shown in the figure). The film tearing unit is disposed at one side of the alignment unit 140 and is configured to perform film tearing on the polarized plate 150 from the alignment unit 140. The attaching unit is disposed at one side of the film tearing unit and is configured to attach the polarized plate 150 from the film tearing unit to the display panel.

In an embodiment, the image sensing and processing unit 121 further includes a set of mark comparison software.

In an embodiment, the check mark 151 is an outline mark and/or a color mark.

In an embodiment, the polarized plate 150 includes a polarizer, a phase difference film, and a protective film.

Beneficial effects of this application are: a mismatching problem of a polarized plate of a conventional polarizer attaching machine can be effectively resolved.

Terms such as “in some embodiments” and “in various embodiments” are repeatedly used. Usually, the terms do not refer to a same embodiment; but they may also refer to a same embodiment. Words such as “comprise”, “have”, “include” are synonyms, unless other meanings are indicated in the context.

The foregoing descriptions are merely preferred embodiments of this application, and are not intended to limit this application in any form. Although this application has been disclosed above through the preferred embodiments, the embodiments are not intended to limit this application. Any person skilled in the art can make some equivalent variations or modifications according to the foregoing disclosed technical content without departing from the scope of the technical solutions of this application to obtain equivalent embodiments. Any simple amendment, equivalent change or modification made to the foregoing embodiments according to the technical essence of this application without departing from the content of the technical solutions of this application shall fall within the scope of the technical solutions of this application.

What is claimed is:

1. An apparatus for attaching a polarized plate with at least one check mark, comprising:
a carrying platform, configured to carry a polarized plate, wherein the polarized plate has the check mark;
a drawing unit, disposed at one side of the carrying platform and configured to draw the polarized plate out of the carrying platform;
an image sensing and processing unit, disposed above the drawing unit and configured to photograph the mark of the polarized plate, and to compare the mark with a mark of a polarized plate standard template to determine whether the marks conform to each other;
a cleaning unit, disposed at one side of the drawing unit and configured to clean the polarized plate from the drawing unit; and
an alignment unit, disposed at one side of the cleaning unit and configured to align the polarized plate from the cleaning unit with a display panel.

2. The apparatus for attaching a polarized plate with at least one check mark according to claim 1, wherein the image sensing and processing unit comprises a plurality of photographing cameras and a backlight source.

3. The apparatus for attaching a polarized plate with check mark according to claim 2, wherein the image sensing and processing unit further comprises a set of mark comparison software.

4. The apparatus for attaching a polarized plate with check mark according to claim 1, wherein the check mark is an outline mark.

5. The apparatus for attaching a polarized plate with check mark according to claim 1, wherein the check mark is a color mark.

6. The apparatus for attaching a polarized plate with check mark according to claim 1, further comprising: a film tearing unit, disposed at one side of the alignment unit and configured to perform film tearing on the polarized plate from the alignment unit; and an attaching unit, disposed at one side of the film tearing unit and configured to attach the polarized plate from the film tearing unit to the display panel.

7. The apparatus for attaching a polarized plate with check mark according to claim 1, wherein the polarized plate comprises a polarizer, a phase difference film, and a protective film.

8. A method for checking a polarized plate mark, comprising:
providing an apparatus for attaching a polarized plate with at least one check mark; placing a polarized plate on the carrying platform, wherein the polarized plate has the check mark;
drawing the polarized plate out of the carrying platform;
photographing the check mark of the polarized plate and comparing the check mark with a mark of a polarized plate standard template to determine whether the marks conform to each other;
drawing the polarized plate out when the check mark of the polarized plate does not conform to the mark of the polarized plate standard template; and
cleaning the polarized plate when the check mark of the polarized plate conforms to the mark of the polarized plate standard template.

9. The method for checking a polarized plate mark according to claim 8, further comprising:
comparing the check mark of the polarized plate with the mark of the polarized plate standard template by using a mark comparison software;
drawing the polarized plate out when the mark comparison software determines that an outline mark of the polarized plate does not conform to an outline mark of the polarized plate standard template; and
drawing the polarized plate out when the mark comparison software determines that a color mark of the polarized plate does not conform to a color mark of the polarized plate standard template.

10. The method for checking a polarized plate mark according to claim 9, further comprising: cleaning the polarized plate when the mark comparison software determines that the outline mark and the color mark of the polarized plate conform to the outline mark and the color mark of the polarized plate standard template.

11. The method for checking a polarized plate mark according to claim 8, further comprising: photographing the check mark of the polarized plate by using an image sensing and processing unit, and comparing the check mark with the mark of the polarized plate standard template to determine whether the marks conform to each other, wherein the image sensing and processing unit comprises a plurality of photographing cameras and a backlight source.

12. The method for checking a polarized plate mark according to claim 8, wherein the image sensing and processing unit further comprises a set of mark comparison software.

13. The method for checking a polarized plate mark according to claim 8, wherein the mark is an outline mark.

14. The method for checking a polarized plate mark according to claim 8, wherein the mark is a color mark.

15. The method for checking a polarized plate mark according to claim 8, further comprising: providing a film tearing unit, disposed at one side of the alignment unit and configured to perform film tearing on the polarized plate from the alignment unit; and an attaching unit, disposed at one side of the film tearing unit and configured to attach the polarized plate from the film tearing unit to the display panel.

16. The method for checking a polarized plate mark according to claim 8, wherein the polarized plate comprises a polarizer, a phase difference film, and a protective film.

17. An apparatus for attaching a polarized plate with at least one check mark, comprising:
a carrying platform, configured to carry a polarized plate, wherein the polarized plate has the check mark;
a drawing unit, disposed at one side of the carrying platform and configured to draw the polarized plate out of the carrying platform;
an image sensing and processing unit, disposed above the drawing unit and configured to photograph the check mark of the polarized plate and compare the check mark with a mark of a polarized plate standard template to determine whether the marks conform to each other;
a cleaning unit, disposed at one side of the drawing unit and configured to clean the polarized plate from the drawing unit;
an alignment unit, disposed at one side of the cleaning unit and configured to align the polarized plate from the cleaning unit with a display panel;
a film tearing unit, disposed at one side of the alignment unit and configured to perform film tearing on the polarized plate from the alignment unit; and
an attaching unit, disposed at one side of the film tearing unit and configured to attach the polarized plate from the film tearing unit to the display panel, wherein the image sensing and processing unit comprises a plurality of photographing cameras, a backlight source, and a set of mark comparison software;
the mark is an outline mark and/or a color mark; and
the polarized plate comprises a polarizer, a phase difference film, and a protective film.
